(19) United States
(12) Patent Application Publication
(10) Pub. No.: US 2019/0307274 A1
(43) Pub. Date: Oct. 10, 2019

(54) PAPER STRAW

(71) Applicant: Yu-Ting HSU, Taipei (TW)

(72) Inventor: Yu-Ting HSU, Taipei (TW)

(21) Appl. No.: 15/946,769

(22) Filed: Apr. 6, 2018

(51) Int. Cl. A47G 21/18; B31C 3/04

(52) U.S. Cl. CPC A47G 21/18; B31C 3/04

(57) ABSTRACT

A paper straw for drinks is revealed. The paper straw includes a base material formed by a paper strip made from calcium carbonate. The base material is wound around an axis of a roller shaft obliquely and overlapped to form a hollow spiral tube whose two ends are communicated. Overlapped portions one over the other on the base material of the spiral tube are tightly connected. The paper straw that is environmentally sustainable, degradable and convenient to use can replace the plastic straw. The paper straw has premium quality and high performance.

### BACKGROUND OF THE INVENTION

### Field of the Invention

The present invention relates to a paper straw, especially to a paper straw for drinks which is able to replace plastic straws, environmentally sustainable, degradable, convenient to use and having premium quality and high performance.

### Description of Related Art

Although people in different countries use different tableware owing to their food culture, they all use straws to drink.

Packaged beverages and handmade drinks are getting popular along with a higher living standard. Thus there is a huge amount of plastic straws used every day all over the world. Most of the straws available now are made from plastic. Although each straw only has a small volume, the overall amount of the straws consumed every day is astonishing. Due to the limited volume, the reuse rate and the value of the plastic straws after recycling are low and are difficult to deal with. The hundreds of billions of the plastic straws used annually not only harm organisms and the environment and pollute the oceans but also take a lot of time to deal with so that high treatment cost is needed. Moreover, the plasticizer residue on the plastic straw or the plasticizer volatilized after exposure to heat poses negative effect on human health.

In order to solve the above problems of the conventional plastic straw, reusable straws made from stainless steel or glass are available on the market. However, not only the cost is high, cleaning and sterilization are also required for reuse. Thus these straws are unable to replace the conventional plastic straw due to difficulty in carry, low penetration rate and no economic edge.

Refer to Taiwanese Utility Pat. No. 355980, a paper straw is disclosed. The paper straw is produced by molds and pressing mechanisms. Refer to FIG. 1 and FIG. 2, joining edges 101 along the length of a hollow tube 10 are overlapped and pressed by the pressing machine to be attached to each other and connected tightly. Thus a paper straw is produced.

However, the hollow tube 10 with the joining edges and a constant diameter is unable to form a flexible segment. Moreover, the joining edges 101 overlapped and pressed often have poor adhesion/attachment and the yield rate is low. The joining edges 101 may also be separated due to aging caused by temperature/moisture content during storage or storage time. Thus the paper straw can't be used. There is room for improvement and a need to provide a novel paper straw.

### SUMMARY OF THE INVENTION

Therefore it is a primary object of the present invention is to provide a paper straw that is environmentally sustainable, degradable, convenient to use and having premium quality and performance for replacing plastic straws, reducing the amount of plastic waste and protecting people's health.

In order to achieve the above object, a paper straw according to the present invention includes a base material formed by a paper strip containing calcium carbonate. The base material is wound around an axis of a roller shaft obliquely and overlapped to form a spiral tube whose two ends are communicated. Overlapped portions one over the other on the base material of the spiral tube are tightly connected to form the paper straw.

The overlapped portions are securely joined by adhesion.

The overlapped portions are closely connected by melt pressing.

The base material is the paper strip made from mixture of calcium carbonate and resin.

The width of the overlapped portion is ranging from one-half to one-fourth of the width of the base material.

A waterproof layer is applied to surface of the spiral tube.

One end of the spiral tube is provided with an inserted portion.

The width of the overlapped portion of the inserted portion is larger than the width of the overlapped portion of the rest part of the spiral tube.

The spiral tube includes a flexible portion.

The width of the overlapped portion of the flexible portion is smaller than the width of the overlapped portion of the rest part of the spiral tube.

The present paper straw has advantages of reliable quality, good performance, easy production and high yield rate. The present paper straw is not only having better strength and comfortable grip but also environmentally friendly, degradable, and convenient to use. Thus the plastic draw can be replaced by the present paper straw and the amount of plastic waste is reduced. Thereby the impact and harm of the straw to the environment and ecosystems can be minimized.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a prior art;

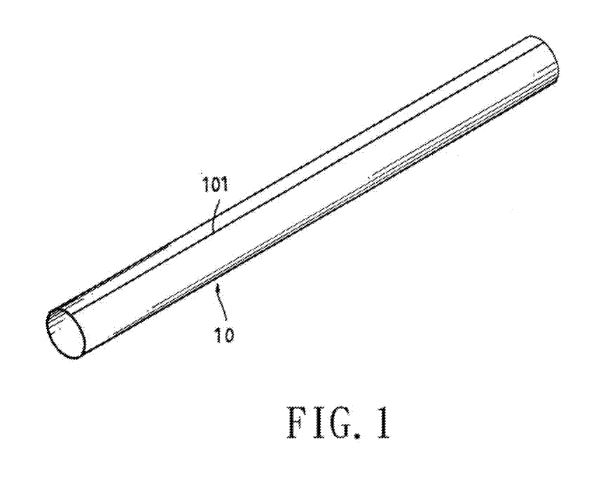

FIG. 2 is a sectional view of a prior art;

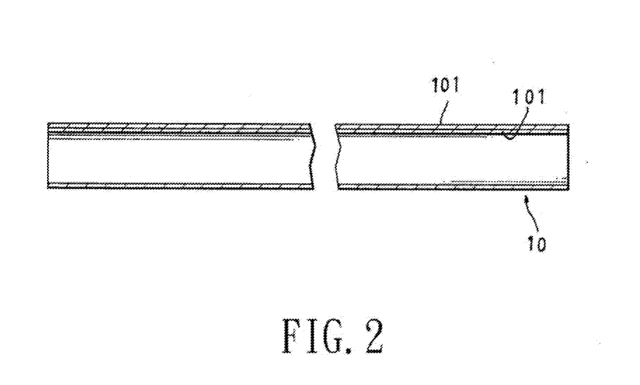

FIG. 3 is a schematic drawing showing structure of an embodiment according to the present invention;

FIG. 4 is a partial enlarged view of an embodiment according to the present invention;

FIG. 5 is a partial enlarged view of another embodiment according to the present invention;

FIG. 6 is a partial enlarged view of a further embodiment according to the present invention.

### DETAILED DESCRIPTION OF THE PREFERRED EMBODIMENT

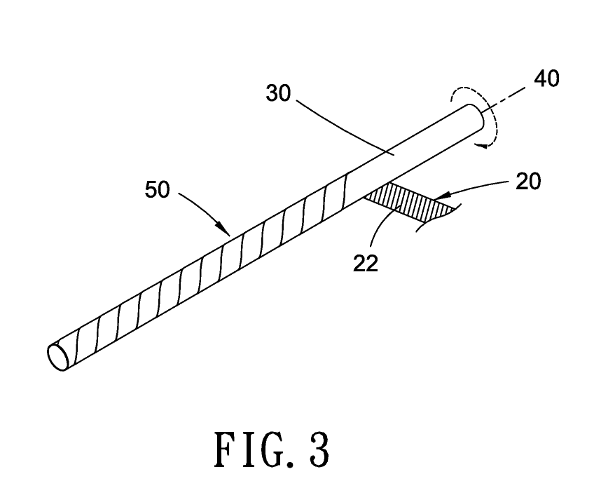

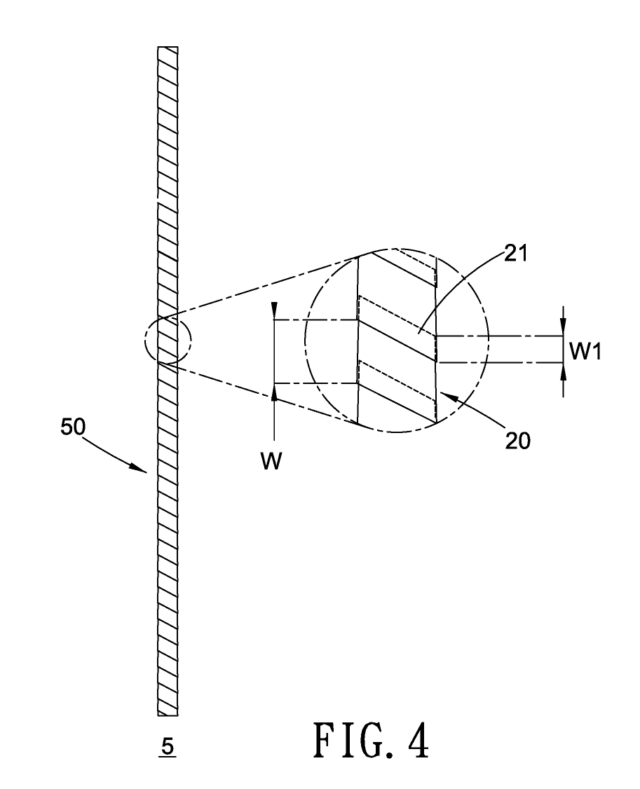

Refer to FIG. 3 and FIG. 4, both are showing structure of an embodiment of a paper straw according to the present invention.

The paper straw of the present invention includes a base material 20 that is a paper strip with a certain width W and made from mixture of calcium carbonate and resin (so-called stone paper/rich mineral paper). The main component of the base material 20 is calcium carbonate obtained by the crashed natural stone. The calcium carbonate can be degraded and embrittled in the environment and then returned to the earth. Once the calcium carbonate is delivered into an incinerator, no smoke or toxic gases are generated so that secondary pollution caused by incineration is minimized. Compared with pulp paper, the cost of the stone paper is much lower (only sixty or seventy percent of the pulp paper). Thus the stone paper is cost effective and having competitive advantage in the paper industry. Moreover, the adverse effects of logging on ecosystems are minimized.

The above base material 20 is passed through a forming machine (not shown in figure) to be wound around an axis 40 of a roller shaft 30 obliquely and overlapped to form a hollow spiral tube 50 whose two ends are communicated. Two overlapped portions 21 on the base material 20 of the spiral tube 50 are securely joined by different ways such as adhesion or melt pressing. After the spiral tube 50 being formed having a certain length, the spiral tube 50 is cut to get a paper straw 5. The paper straw 5 is non-absorbent and having high waterproof coefficient. Moreover, a waterproof layer 22 can also be coated on surface of the spiral tube 50 so that paper straw 5 produced is waterproof, without becoming soft or absorbing water while being placed into drinks.

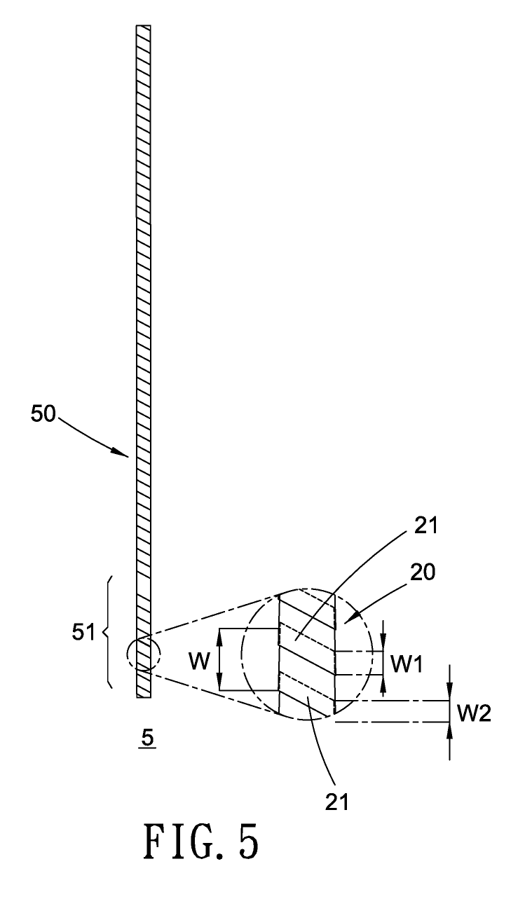

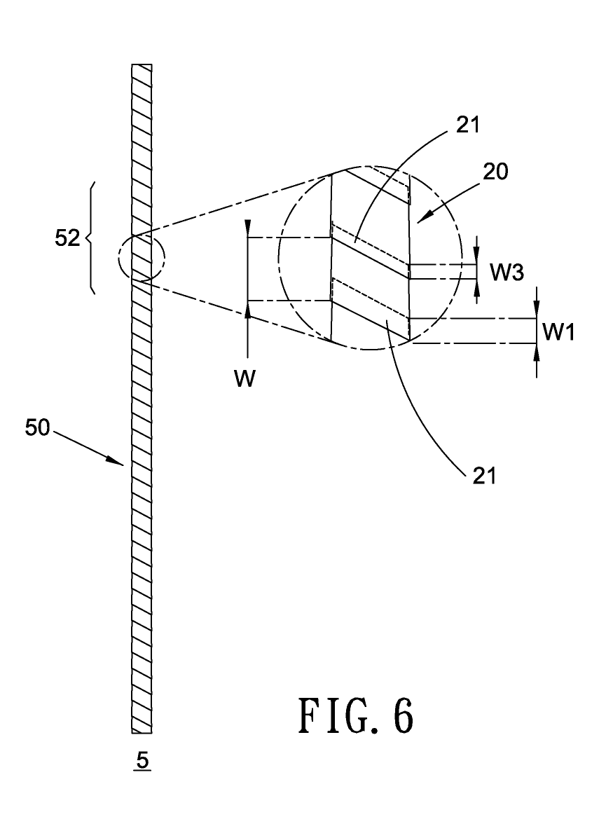

Refer to FIG. 5 and FIG. 6, the strength of the spiral tube 50 is determined by the width W1 of the overlapped portion 21 of the base material 20. For example, the larger the width W1 of the overlapped portion 21, the harder the spiral tube 50 and the more difficult it is to bend. On the other hand, the smaller the width W1 of the overlapped portion 21, the softer the spiral tube 50 and the easier it is to bend. The width W1 of the overlapped portion 21 can be ranging from one-half to one-fourth of the width W of the base material 20 so that the strength of the spiral tube 50 varies from hard to soft and flexible. Thus the paper straw 5 with higher quality and performance is more convenient to use.

In an embodiment shown in FIG. 5, an inserted portion 51 is arranged at one end of the spiral tube 50. The width W2 of the overlapped portion 21 of the inserted portion 51 is larger than the width W1 of the overlapped portion 21 of the rest part of the spiral tube 50. That means the winding on the inserted portion 51 is denser than that on the rest part of the spiral tube 50. A surface with better strength and stress is provided so that the present paper straw can be easily passed through the film over the beverage container.

Refer to FIG. 6, the spiral tube 50 further includes a flexible portion 52. The width W3 of the overlapped portion 21 of the flexible portion 52 is smaller than the width W1 of the overlapped portion 21 of the spiral tube 50. That means the winding on the flexible portion 52 is looser than that on the rest part of the spiral tube 50. Thus the flexible portion 52 is softer and easier to bend.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A paper straw comprising: a base material that is a paper strip containing calcium carbonate; wherein the base material is wound around an axis of a roller shaft obliquely and overlapped to form a hollow spiral tube whose two ends are communicated; overlapped portions one over the other on the base material of the spiral tube are tightly connected.

2. The device as claimed in claim 1, wherein the overlapped portions on the base material are tightly connected by adhesion.

3. The device as claimed in claim 1, wherein the overlapped portions on the base material are tightly connected by melt pressing.

4. The device as claimed in claim 1, wherein the base material is the paper strip made from mixture of calcium carbonate and resin.

5. The device as claimed in claim 1, wherein width of the overlapped portion is ranging from one-half to one-fourth of width of the base material.

6. The device as claimed in claim 1, wherein one end of the spiral tube is provided with an inserted portion.

7. The device as claimed in claim 6, wherein width of the overlapped portion of the inserted portion is larger than width of the overlapped portion of the rest part of the spiral tube.

8. The device as claimed in claim 1, wherein the spiral tube includes a flexible portion.

9. The device as claimed in claim 8, wherein width of the overlapped portion of the flexible portion is smaller than width of the overlapped portion of the rest part of the spiral tube.
